(19) United States
(12) Patent Application Publication
(10) Pub. No.: US 2020/0288691 A1
(43) Pub. Date: Sep. 17, 2020

(54) Fishing Bait Inflator and Method of Using the Same

(71) Applicant: Mark A. Carota, Rexford, NY (US)

(72) Inventor: Mark A. Carota, Rexford, NY (US)

(21) Appl. No.: 16/352,505

(22) Filed: Mar. 13, 2019

(51) Int. Cl. A01K 97/04; F04B 45/02; F04B 33/00

(52) U.S. Cl. CPC A01K 97/045; F04B 33/00; F04B 45/02

(57) ABSTRACT

An apparatus and method for inflating fishing bait is disclosed. The apparatus is comprised of a compressible air reservoir, and needle, wherein a distal end of the needle is operably coupled to the compressible air reservoir. A proximal end of the needle terminates in a dull hollow rectangular prism. There is a continuous air passage between the dull hollow rectangular prism of the needle and the compressible air reservoir. The compressible air reservoir has a vent such that it can refill with air while the continuous air passage through the needle is obstructed. The vent can be covered up by a hand of a user when the apparatus is in use.

### I. FIELD OF THE INVENTION

The present invention relates generally to an apparatus for inflating bait. More specifically, the present invention relates to an apparatus and method for inflating fish bait, e.g. a worms used for fishing.

### BACKGROUND

In fishing, trout and other fish tend to respond more to bait that has some measure of buoyancy. One method of increasing the buoyancy of a worm has been to inject small bubbles of air under the worm's skin with some sort of needle and air compressor. However, needles tend to come to a sharp point, which risks injury, and require an air-proof seal, which requires that the needle be the source of all air entering and exiting the apparatus. Therefore, there is a present need for a fishing bait inflator that does not have a sharp point, and that has a method of inflation that allows the apparatus to be filled with air while the needle is in use.

### SUMMARY OF THE INVENTION

A first aspect of the present invention is an apparatus for inflating fishing bait. The apparatus is comprised of a compressible air reservoir, and needle, wherein the distal end of the needle is operably coupled to the compressible air reservoir. The proximal end of the needle terminates in a dull hollow rectangular prism. There is a continuous air passage between the dull hollow rectangular prism of the needle and the compressible air reservoir. The compressible air reservoir has a vent such that it can refill with air while the continuous air passage through the needle is obstructed. The vent can be covered up by a hand of a user when the apparatus is in use.

A second aspect of the present invention is a method for inflating fishing bait, such as, for example, worms, using an apparatus comprising a compressible air reservoir coupled to a needle. In a first step, the apparatus for inflating the fishing bait via the needle is provided. In a second step, the needle is placed against the skin of bait. In a third step, a vent, such as, for example a vent, in the compressible air reservoir is covered with the hand of a user. In a fourth step, the compressible air reservoir is gently compressed to gradually inflate the skin of the worm. In a fifth step, the needle is removed from the skin of the worm. In a sixth step the compressible air reservoir is vented by uncovering a vent in the side of the compressible air reservoir. In a seventh step, the compressible air reservoir is allowed to re-inflate.

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 depicts a side view of the apparatus, in accordance with embodiments of the present invention; and

FIG. 2 depicts a side view of the apparatus while in use inflating a worm, in accordance with embodiments of the present invention;

FIG. 3 depicts a flowchart for a method of inflating fishing bait, in accordance with embodiments of the present invention; and

FIG. 4 depicts the side view of the apparatus depicted in FIG. 2 after inflating the worm, in accordance with embodiments of the present invention.

### DETAILED DESCRIPTION OF THE EMBODIMENTS OF THE INVENTION

Definitions:

Herinafter, unless defined otherwise, a check valve is defined as a valve that doses to prevent backward flow of air.

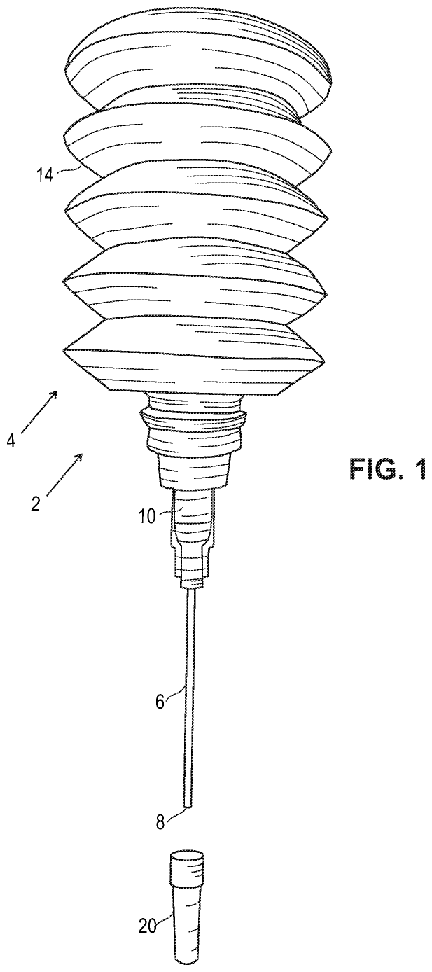

FIG. 1 depicts a side view of the apparatus, in accordance with embodiments of the present invention. The apparatus 2 is comprised of a compressible air reservoir 4, and needle 6, where the distal end of the needle 6 is operably coupled to the compressible air reservoir 4. The proximal end of the needle terminates in a dull hollow rectangular prism 8, such that said proximal end is a blunt end. There is a continuous air passage 10 between the dull hollow rectangular prism 8 of the needle 6 and the compressible air reservoir 4. The compressible air reservoir 4 has a vent 12, such as, for example, a hole, such that the compressible air reservoir 4 can refill with air while the continuous air passage 10 through the needle 6 is obstructed. The vent 12 can be covered up by a hand of a user when the apparatus is in use.

In an embodiment, the compressible air reservoir contains retractable baffles 14.

In an embodiment, the vent 12 additionally contains a one way valve 16, e.g. a check valve.

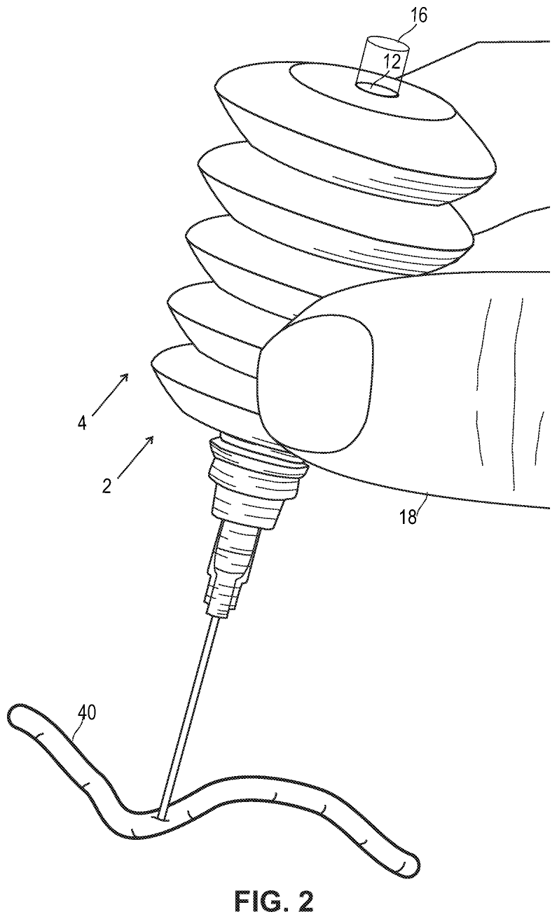

In an embodiment, the compressible air reservoir 4 is shaped so that the vent 12 is easily covered by the thumb 18 of the user, as shown in FIG. 2.

In an embodiment, the dull hollow rectangular prism 8 is covered by a removable safety cap 20.

In an embodiment, the dull hollow rectangular prism 8 is small enough to successfully pierce the skin of a worm, but not sharp enough to pierce the skin of the user.

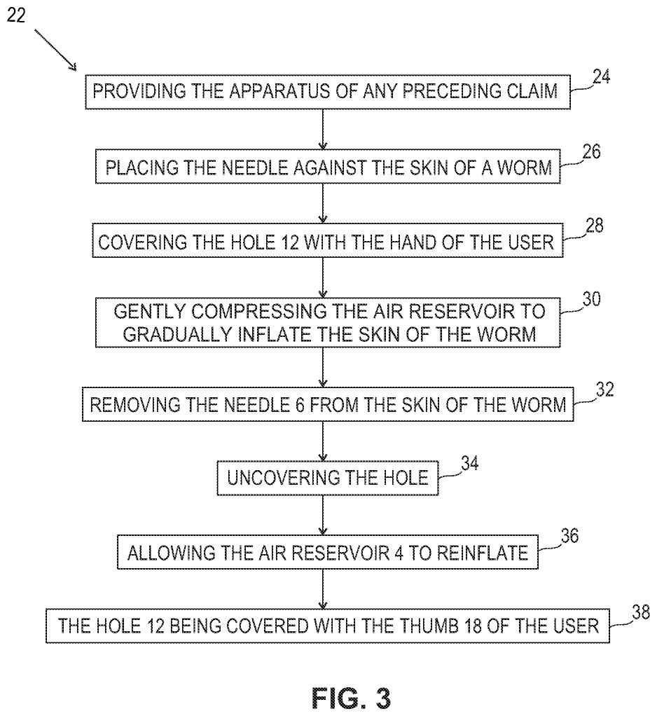

FIG. 3 depicts a flowchart for a method 22 of inflating fishing bait. The method 22 of inflating fishing bait comprises. A first step 24 of the method 22 is comprised of providing the apparatus of any preceding claim. A second step 26 of the method 22 comprises placing the needle against the skin of a worm. A third step 28 of the method 22 comprises covering the vent 12 with the hand of the user. A fourth step 30 of the method 22 comprises gently compressing the air reservoir to gradually inflate the skin of the fish bait 40, e.g. a worm. A fifth step 32 of the method 22 comprises removing the needle 6 from the skin of the fish bait 40, e.g. a worm. A sixth step 34 of the method 22 comprises uncovering the vent. A seventh step 36 of the method 22 comprises allowing the air reservoir 4 to re-inflate. In an embodiment, there is an eighth step 38 of the method 22 comprised of the vent 12 being covered with the thumb 18 of the user.

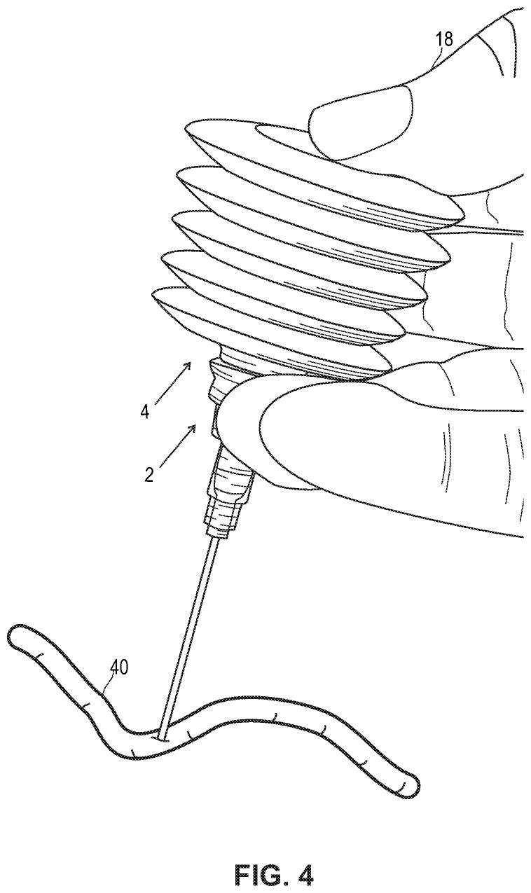

FIG. 4 depicts the side view of the apparatus depicted in FIG. 2 after inflating the fish bait 40, e.g. a worm, as in step 30 of the method 22, comprising gently compressing the air reservoir to gradually inflate the skin of the fish bait 40, e.g. a worm.

While exemplary embodiments have been specifically disclosed, it should be understood that the practice of this invention is not limited to those embodiments. Modifications and variations falling within the spirit of the invention will occur to those skilled in the art. Therefore, it is not intended that the scope of the invention be determined by the disclosed exemplary embodiments, but rather should be determined by the breadth of the appended claims.

I claim:

1. An apparatus for inflating fishing bait, comprising:
a compressible air reservoir,
a needle, wherein the distal end of the needle is operably coupled to the compressible air reservoir,
wherein the proximal end of the needle terminates in a dull hollow rectangular prism,
wherein there is a continuous air passage between the dull hollow rectangular prism and the compressible air reservoir, and
wherein the compressible air reservoir has a vent such that the compressible air reservoir can refill with air while the continuous air passage through the needle is obstructed, and
wherein the vent can be covered up by a hand of a user when the apparatus is in use.

2. The apparatus of claim 1, wherein the compressible air reservoir contains retractable baffles.

3. The apparatus of claim 1, wherein the vent additionally contains a one way valve.

4. The apparatus of claim 1, wherein the compressible air reservoir is shaped so that the vent is easily covered by the thumb of the user.

5. The apparatus of claim 1, wherein the dull hollow rectangular prism is covered by a removable safety cap.

6. The apparatus of claim 1, wherein the dull hollow rectangular prism is small enough to successfully pierce the skin of a worm, but not sharp enough to pierce the skin of the user.

7. A method of inflating fishing bait comprising,
providing the apparatus of any preceding claim,
placing the needle against the skin of a worm,
covering the vent with the hand of the user,
gently compressing the air reservoir to gradually inflate the skin of the worm,
removing the needle from the skin of the worm,
uncovering the vent, and
allowing the air reservoir to re-inflate.

8. The method of claim 7, wherein the vent is covered with the thumb of the user.
